(19) United States
(12) Patent Application Publication
(10) Pub. No.: US 2024/0199342 A1
(43) Pub. Date: Jun. 20, 2024

(54) CONVEYOR ROLLER

(71) Applicant: INTERROLL HOLDING AG, Sant'Antonino (CH)

(72) Inventors: Erwin Mans, Hückelhoven (DE); Kai Lubomierski, Hückelhoven (DE); Jürgen Zinn, Hückelhoven (DE); Stephan Kronholz, Hückelhoven (DE)

(21) Appl. No.: 18/555,522

(22) PCT Filed: Apr. 8, 2022
(86) PCT No.: PCT/EP2022/059440

§ 371 Date: Oct. 14, 2023

(30) Foreign Application Priority Data
Apr. 15, 2021 (DE) 10 2021 109 540.9

(51) Int. Cl. B65G 39/07; B65G 13/08; B65G 39/09

(52) U.S. Cl. CPC B65G 39/07; B65G 13/08; B65G 39/09

(57) ABSTRACT

Conveyor roller for a conveyor device, in particular for conveying an object, in particular packaged food, the conveyor roller comprises a cylindrical roller body which can be mounted rotatably about an axis of rotation; a conical sleeve (3), having at least one sleeve element, the conical sleeve being arranged coaxially around the roller body and forming a conveyor surface for an object to be conveyed, wherein the sleeve element comprises a first axial sleeve element end and a second axial sleeve element end; wherein the first axial sleeve element end sealingly abuts the roller body, and that the second axial sleeve element end sealingly abuts the roller body.

### TECHNICAL FIELD

The invention relates to a conveyor roller.

### BACKGROUND OF THE INVENTION

DE 10 2016 125 136 B4 discloses a conveyor roller for a conveyor device for conveying containers, pallets and the like, with a cylindrical roller body. One or more conical sleeves are arranged on the roller body.

In the food processing industry, the requirements for hygiene and the conveyor devices used are very high. The devices must be easily accessible for cleaning purposes; no shelter must be provided for any contaminants. Cleaning liquid must always drain off well.

### SUMMARY OF THE INVENTION

It is the object of the present invention to provide an improved conveyor roller. An exemplary conveyor roller includes a cylindrical roller body, which can be mounted rotatably about an axis of rotation; a conical sleeve, having at least one sleeve element, the conical sleeve being arranged coaxially around the roller body and forming a conveyor surface for an object to be conveyed. The sleeve element includes a first axial sleeve element end and a second axial sleeve element end. The first axial sleeve element end sealingly abuts the roller body, and the second axial sleeve element end sealingly abuts the roller body.

The sealing contact of the sleeve element ends with the roller body prevents material of any kind from penetrating between the sleeve element and the roller body. The sealing effect can be achieved by an interference fit of the sleeve element end. Alternatively or additionally, the sealing effect can be achieved by separate sealing means such as a sealing ring.

In one embodiment, a tube section of the sleeve element lies coaxially around the conveyor roller, preferably over the entire length between the two sleeve element ends. This contact over the entire length means that no space is available for any impurities between the sleeve element and the tube section.

In one embodiment, the sleeve element forms a closed peripheral surface. The peripheral surface has no interruptions on the outer circumference, only a central hole is formed to allow the roller body to be inserted.

The sleeve element is formed in particular from plastic, in particular as a plastic injection molded part.

In one embodiment, the sleeve element has a plurality of radial projections which extend in particular radially outwardly from the tube section. The projections thus form a conveyor surface for the object to be conveyed at a large radial distance from the axis of rotation without the sleeve elements having to be made of solid material or having cavities. It should be noted that plastic injection molded parts have a maximum wall thickness of 15 mm, preferably 10 mm, due to the manufacturing process. Sleeve elements made from solid material, on the other hand, would also be expensive and heavy, in addition to any manufacturing difficulties. Preventing cavities in turn makes it easier to comply with hygiene requirements.

In one embodiment, the radial projections are designed as radial lamellae. Viewed in the axial direction, such a radial lamella forms in particular a closed ring which extends from the tube section or the roller section to the conveyor surface.

In addition, the conical sleeve can have a sleeve element which, in particular, does not have any radial projections. Here, the radial distance from the inner peripheral surface to the conveyor surface can be completely formed by a solid material. This sleeve element is particularly suitable at a first end of the conveyor roller, or of the conical sleeve, as at the conical area with the smallest diameter.

In this respect, in one embodiment the conveyor roller has a conical sleeve with a first sleeve element (in particular without radial projections) and with a second sleeve element (with radial projections).

The conveyor roller is particularly suitable for conveying food, especially packaged food.

The conveyor roller is particularly suitable for conveying an object along a curve, especially along a roller curve.

The terms “first”, “second” serve to individualize a component or element and do not necessarily presuppose a certain number of components or elements. Thus, a second element can be provided without the existence of a first element being mandatory.

### BRIEF DESCRIPTION OF THE DRAWINGS

The invention is explained in more detail by way of example with reference to the figures below, herein showing

FIG. 1 depicts an exemplary conveyor roller according to the invention, where panel a) provides a perspective view, panel b) shows a longitudinal section view, and panel c) shows a transport mode in a side view;

FIG. 2 depicts an exemplary first sleeve element of a conveyor roller, where panel a) is a perspective view, panel b) is a longitudinal sectional view, and panel c) is a cross-sectional view along the intersection c-c in panel b);

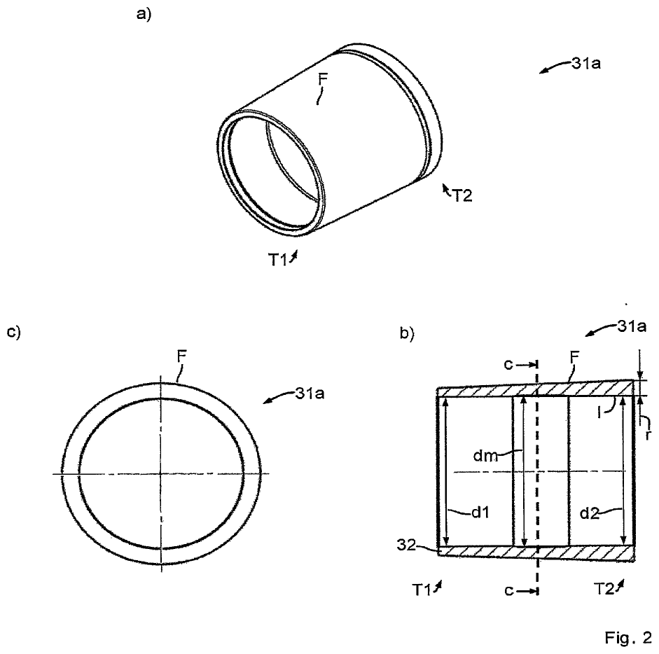

FIG. 3 depicts an exemplary second sleeve element of a conveyor roller where panel a) is a perspective view, panel b) is a longitudinal sectional view, and panel c) is a cross-sectional view along the line of intersection c-c in panel b);

FIG. 4 is another exemplary second sleeve element of a conveyor roller, where panel a) is a perspective view, panel b) is a longitudinal sectional view, and panel c) is a cross-sectional view along the line of intersection c-c in panel b);

FIG. 5 is a schematic top view of a conveyor device with a plurality of conveyor rollers according to FIG. 1.

### DETAILED DESCRIPTION OF PREFERRED EMBODIMENTS

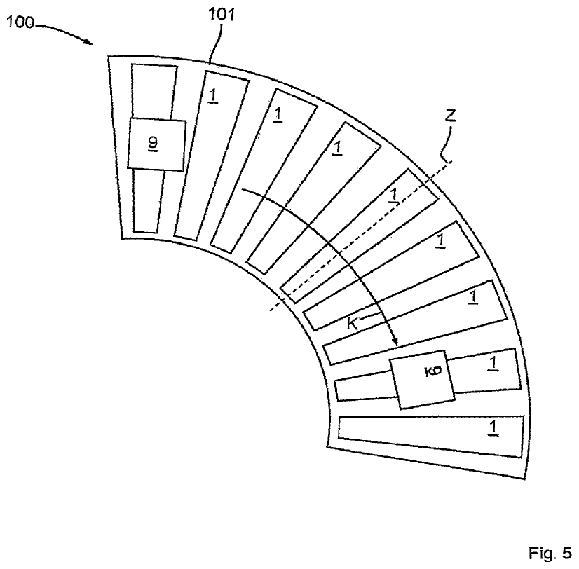

FIG. 5 shows a conveyor device 100 according to the invention. The conveyor device includes a frame 101 on which a plurality of conveyor rollers 1 are arranged one behind the other along a conveying direction K. The conveying direction describes a curve, and thus at least in sections deviates from a straight line.

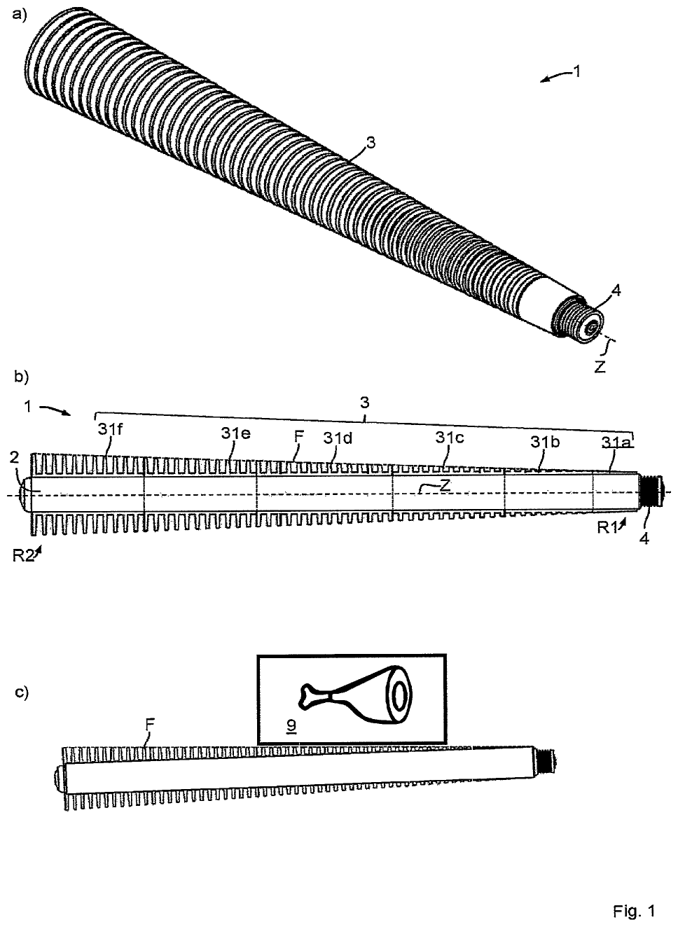

To support the curved travel of an object 9, the conveyor rollers each have conical outer peripheral surfaces, which together form a conveyor surface F for the object 9 (FIG. 1, panel c)). Some of the conveyor rollers can be motor rollers, which themselves have an integrated drive.

Some of the conveyor rollers may be passive conveyor rollers driven by an external drive source. The conveyor rollers can be connected to each other and/or to another drive source via a drive head 4 (FIG. 1) and drive means connected thereto (e.g. poly-V belts). Such conveyor rollers with a conical outer peripheral surface as the conveyor surface are known in principle from DE 10 2016 125 136 B4.

The conveyor device 100 according to the invention includes a plurality of conveyor rollers, as described below.

FIG. 1 shows a conveyor roller according to the invention. The conveyor roller 1 includes a cylindrical roller body 2, which can be connected to the frame shown in FIG. 5 so that it can rotate about an axis of rotation Z. The roller body 2 can be mounted on the frame 101. For this purpose, the conveyor roller has pivot bearings which are not shown. A drive head 4 is at least indirectly non-rotatably connected to the roller body 2. A conical sleeve 3 is fitted around the roller body 2. At its radially outer end, the conical sleeve 3 provides a conveyor surface F on which the object to be conveyed 9 (FIG. 5) comes to rest. Due to the conical shape, the conveyor surface F is arranged closer to the axis of rotation Z at a first roller end R1 than at a second roller end R2.

The conical sleeve 3 is in particular made up of several elements and has a plurality of sleeve elements 31. The sleeve elements 31 are arranged axially adjacent to one another (in relation to the axis of rotation Z).

In one variation, the conical sleeve 3 may include only one sleeve element.

A first sleeve element 31a is disposed adjacent the first roller end R1. A second sleeve element 31f is arranged adjacent to the second roller end R2. Depending on the length, further sleeve elements 31b . . . 31e can be provided between the first and second sleeve elements 31a, 31f to support different lengths of the conveyor roller 1. The distinction between the first and second sleeve elements 31a, 31f is made on the basis of the different structure of the two sleeve elements 31a, 31f.

Each sleeve element has an axial first sleeve element end T1 and a second sleeve element end T2.

A radial distance r of the conveyor surface F from an inner peripheral surface I increases in the axial direction from the first sleeve element end T1 to the second sleeve element end T2.

Each sleeve element is formed in one piece and has a hollow cylindrical tube section 32 extending along the axial length of the sleeve element 31.

The tube section 32 is dimensioned in each case in such a way that no gap is provided between an inner peripheral surface I of the tube section 32 and the roller body 2, in which moisture and thus also impurities can accumulate.

At the first and second ends T1, T2, an inner diameter d1, d2 of the sleeve element is dimensioned in such a way that the sleeve element rests on the roller body 2 at the respective end with an interference fit. In a middle section M between the first and second ends R1, R2, an inner diameter dm can be slightly enlarged, so that here there is a smaller pressing (including no pressing) between the roller body 2 and the tube section 32. Nevertheless, it is preferred if also in the middle section the sleeve element 31 is in complete contact with the roller body 2, in particular with a clearance fit, in order to provide no space for the accumulation of impurities, moisture and thus the generation of germs.

The first sleeve element 31a has a conical outer peripheral surface at the tube section 32, the maximum wall thickness of the sleeve element being 8 mm, for example. A radial distance r of the inner peripheral surface I of the tube section from the conveyor surface F is also a maximum of 8 mm in this case, so that the sleeve element can be manufactured as a fully injection-molded part without cavities being formed between the conveyor surface F and the inner peripheral surface I.

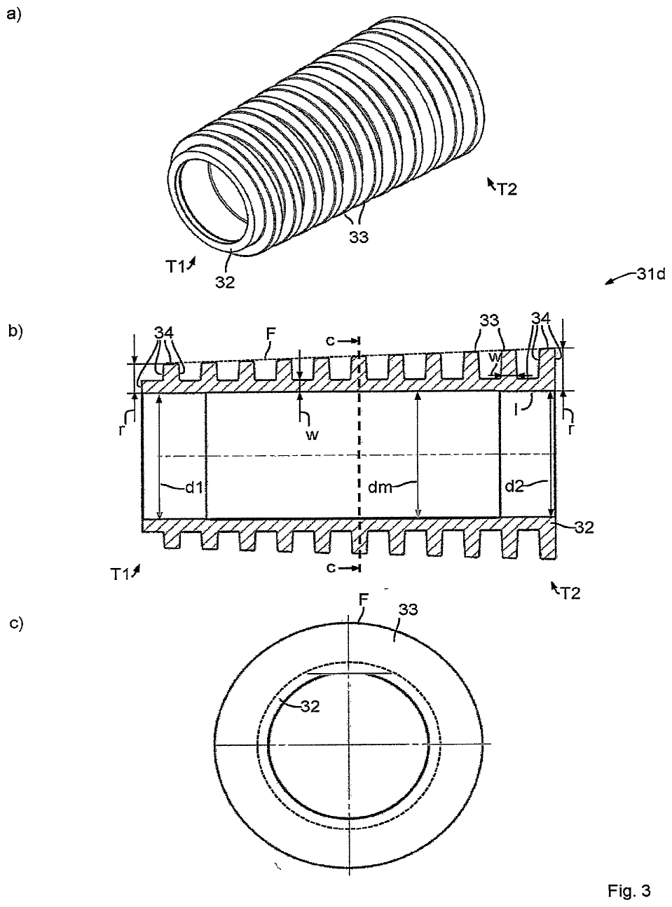

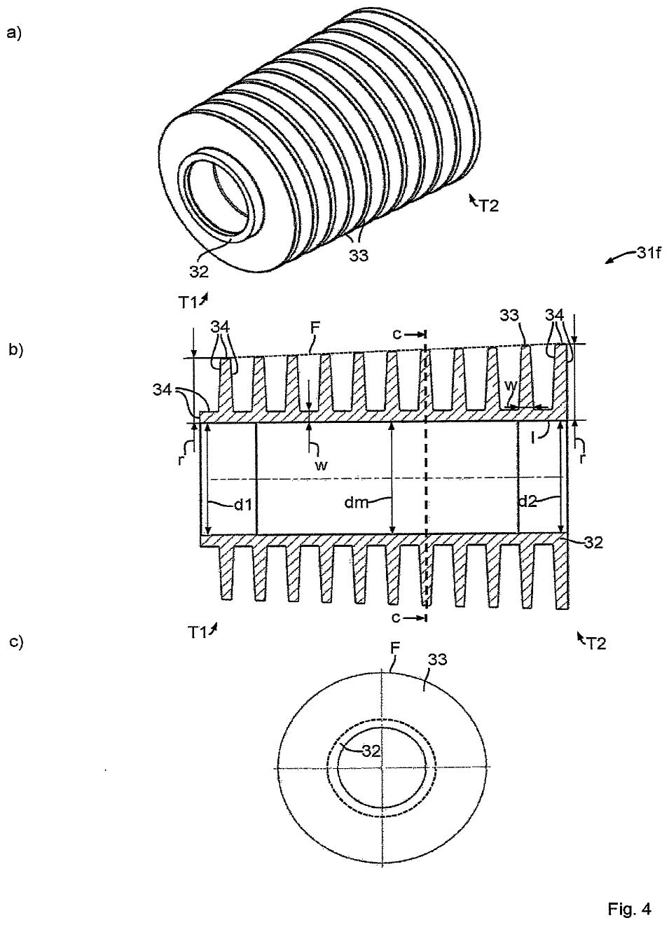

With reference to FIGS. 3 and 4, a second sleeve element 31d, 31f is described below in each case as an example of the remaining second sleeve elements, the description applying to all second sleeve elements. Any variations in the variants of the second sleeve element will be described separately.

It can be seen that a radial distance r between the inner peripheral surface I and the conveyor surface F is greater than in the first sleeve element 31a. A maximum wall thickness w of the sleeve element is, for example, 8 mm. Using a solid material, the radial distance r could only be achieved by wall thicknesses of, for example, more than 10 mm or more than 15 mm. Alternatively, cavities could be incorporated, which is also costly in terms of production technology and also represents an undesirable retreat area for impurities.

According to the invention, the conveyor surface is now not completely continuous but extends at least in sections over a plurality of radial projections. The radial projections 33 are exemplarily formed by axially adjacent annular lamellae, but can alternatively also be formed by columnar projections. Radial in this context means that the projections extend from a radially inner region to a radially outer region. However, the main direction of extension does not necessarily have to be aligned perpendicular to the axis of rotation Z. The wall thicknesses w at the radial projections are also about 8 mm and can therefore be produced by injection molding.

At least two sleeve elements are axially adjacent to each other. They are in contact with each other in such a way that the space between the two sleeve elements is sealed.

The conical sleeve is characterized by the fact that large distances between the inner peripheral surface I and the conveyor surface F can be achieved without large wall thicknesses and cavities. The conveyor roller can be lightweight and meets high hygiene requirements.

### LIST OF REFERENCE SIGNS

1 conveyor roller
2 roller body
3 conical sleeve
4 drive head
9 object to be conveyed
R1 first roller end
R2 second roller end
31a first sleeve element
31b second sleeve element
32 tube section
33 radial projection
34 closed peripheral surface
T1 first sleeve element end
T2 second sleeve element end
F conveyor surface of the sleeve element or conical sleeve
1 inner peripheral surface
r radial distance between inner peripheral surface and conveyor surface
W thickness of sleeve element
K conveying direction
dm inner diameter at center section
d1 inner diameter at first sleeve element end
d2 inner diameter at second sleeve element end
100 conveying device
101 frame

1. A conveyor roller (1) for a conveyor device (100), in particular for conveying an object (9), in particular packaged food, the conveyor roller (1) comprising:
a cylindrical roller body (2) which can be mounted rotatably about an axis of rotation (Z),
a conical sleeve (3), having at least one sleeve element (31), the conical sleeve (3) being arranged coaxially around the roller body (2) and forming a conveyor surface (F) for an object (9) to be conveyed,
wherein the sleeve element (31) comprises a first axial sleeve element end (T1) and a second axial sleeve element end (T2);
wherein the first axial sleeve element end (T1) sealingly abuts the roller body (2), and
wherein the second axial sleeve element end (T2) sealingly abuts the roller body (2).

2. The conveyor roller (1) according to claim 1, wherein sleeve element (31) forms a tube section (32) that lies coaxially around the roller body (2).

3. The conveyor roller (1) according to claim 2, wherein the tube section (32) rests against the roller body (2) over its entice axial length.

4. The conveyor roller (1) according to claim 1, wherein the sleeve element (31) forms a closed peripheral surface (34).

5. The conveyor roller (1) according to claim 1, wherein the sleeve element comprises a plurality of radial projections (33), the plurality of radial projections (33) jointly forming the conveyor surface (F) at a radially outer end in each case.

6. The conveyor roller (1) according to claim 5, wherein the radial projections (33) are formed by axially adjacent radial lamellae.

7. The conveyor roller (1) according to claim 1, wherein the sleeve element is formed in one piece and optionally wherein the radial projections (33) are formed in one piece with the tube section (32).

8. The conveyor roller (1) according to claim 1,
wherein a second sleeve element (31b . . . f) is a plastic injection-molded part with a maximum wall thickness (w) of 15 mm, in particular 10 mm,
wherein a radial distance (r) of the conveyor surface (F) from an inner peripheral surface (I) of the sleeve element (31) at a radial projection (33) is greater than the maximum wall thickness (w), and
optionally wherein the radial distance (r) is greater than 15 mm.

9. The conveyor roller (1) according to claim 1,
wherein a first sleeve element (31a) is a plastic injection-molded part with a maximum wall thickness (w) of 15 mm, optionally 10 mm,
wherein a radial distance (r) of the conveyor surface (F) from an inner peripheral surface (I) of the sleeve element (31) at a radial projection (33) is not greater than the maximum wall thickness (w), and
optionally wherein the first sleeve element (31a) has no radial projection (33).

10. The conveyor roller (1) according to claim 1,
wherein a plurality of sleeve elements (31) are provided, two sleeve elements of the plurality of sleeve elements abutting one another in an axially adjacent manner, and
wherein a first axial sleeve element end (T1) of one sleeve element abuts sealingly against a second axial sleeve element end (T2) of another sleeve element.

11. A conveyor device (100), in particular food conveyor device, along which an object (9) to be conveyed, in particular a packaged food product, can be conveyed along a curve (K), comprising:
a plurality of conveyor rollers (1) according to claim 1.

12. The conveyor device according to claim 1, wherein the object (9) to be conveyed comes to rest directly on at least one sleeve element (31) of the conveyor roller (1).

13. Use of the conveyor device (100) according to claim 9,
wherein:
the sleeve element comprises a plurality of radial projections (33), the plurality of radial projections (33) jointly forming the conveyor surface (F) at a radially outer end in each case, or
the radial projections (33) are formed by axially adjacent radial lamellae,
wherein the object (9) to be conveyed simultaneously comes into contact with at least three radial projections (33).

14. A conveyor roller (1) for a conveyor device (100), in particular for conveying an object (9), in particular packaged food, the conveyor roller (1) comprising:
a cylindrical roller body (2) which can be mounted rotatably about an axis of rotation (Z);
a conical sleeve (3), having at least one sleeve element (31), the conical sleeve (3) being arranged coaxially around the roller body (2) and forming a conveyor surface (F) for an object (9) to be conveyed;
wherein the sleeve element (31) comprises a first axial sleeve element end (T1) and a second axial sleeve element end (T2);
wherein the first axial sleeve element end (T1) sealingly abuts the roller body (2);
wherein the second axial sleeve element end (T2) sealingly abuts the roller body (2);
wherein the tube section (32) rests against the roller body (2) over its entire axial length;
wherein the sleeve element (31) forms a closed peripheral surface (34);
wherein the sleeve element comprises a plurality of radial projections (33), the plurality of radial projections (33) jointly forming the conveyor surface (F) at a radially outer end in each case; and
wherein the sleeve element is formed in one piece.
